(19) United States
(12) Patent Application Publication
(10) Pub. No.: US 2024/0351407 A1
(43) Pub. Date: Oct. 24, 2024

(54) Motorized Windshield Shade Device

(71) Applicant: Jawaun Hardy, Boynton Beach, FL (US)

(72) Inventor: Jawaun Hardy, Boynton Beach, FL (US)

(21) Appl. No.: 18/640,137

(22) Filed: Apr. 19, 2024

Related U.S. Application Data
(60) Provisional application No. 63/460,716, filed on Apr. 20, 2023.

(51) Int. Cl. B60J 1/20

(52) U.S. Cl. CPC B60J 1/2019; B60J 1/2077

(57) ABSTRACT

A motorized windshield shade device is disclosed that comprises a shade component that can be raised and lowered via a push button or by turning off or starting the vehicle ignition. The shade component travels between at least one track and pulley system and motor positioned within the A-pillar of a vehicle between the windshield and the pillar trim. When not in use, the shade component is concealed at the base of the dashboard of the vehicle. Further, the top of the shade component comprises a flexible rod, which allows the shade component to conform to the shape of a windshield. The shade component is raised or lowered over a vehicle windshield to keep the vehicle's interior cool and prevent UV damage.

### CROSS-REFERENCE TO RELATED APPLICATION

The present application claims priority to, and the benefit of, U.S. Provisional Application No. 63/460,716, which was filed on Apr. 20, 2023, and is incorporated herein by reference in its entirety.

### FIELD OF THE INVENTION

The present invention relates generally to the field of motorized windshield shade devices. More specifically, the present invention relates to a motorized windshield shade device that blocks sunlight from entering a vehicle through the vehicle windshield. Accordingly, the present disclosure makes specific reference thereto. Nonetheless, it is to be appreciated that aspects of the present invention are also equally applicable to other like applications, devices and methods of manufacture.

### BACKGROUND

By way of background, this invention relates to improvements in motorized windshield shade devices. Generally, sunlight may damage the interior of a vehicle via UV rays. In addition, vehicles sitting out in the sun for long periods of time become extremely hot. As a result, collapsible vehicle sunshades are used and are temporarily placed behind a vehicle's windshield to block the sun. However, such temporarily sunshades must be consistently and manually placed and removed from behind a windshield, which can be tiring and burdensome.

During the summer months, the sun can easily heat up an interior of a vehicle, particularly when a driver and/or a passenger leave the vehicle. Under these conditions, the vehicle dashboards and upholstery become hot and can injure the driver and/or the passenger upon returning to the vehicle, if the hot interior is touched. Furthermore, there are limited products available on the market that prevent such harsh heat and the sun's ultraviolet (UV) rays from ruining the interior of the vehicle while keeping the vehicle cool at the same time.

Accordingly, there is a demand for an improved motorized windshield shade device that protects the interior of the vehicle from the sun's damaging rays. More particularly, there is a demand for a motorized windshield shade device that maintains a cool temperature within the vehicle even when the sun is shining brightly and prevents a person entering the vehicle from injury due to high temperatures.

Therefore, there exists a long felt need in the art for a motorized windshield shade device that provides users with a means for blocking sunlight from entering a vehicle through the vehicle windshield. There is also a long felt need in the art for a motorized windshield shade device that can be easily placed and removed from behind a vehicle windshield. Further, there is a long felt need in the art for a motorized windshield shade device that is a built-in retractable sunshade for vehicle windshields. Moreover, there is a long felt need in the art for a device that utilizes an integrated track and pulley system inside the vehicle's A-pillar. Further, there is a long felt need in the art for a motorized windshield vehicle device that comprises a semi-flexible rod at the top to conform to the windshield. Finally, there is a long felt need in the art for a motorized windshield shade device that is completely hidden behind the dashboard when not in use.

The subject matter disclosed and claimed herein, in one embodiment thereof, comprises a motorized windshield shade device. The motorized windshield shade device comprises a shade component that can be raised and lowered via a push button or by turning off or starting the vehicle ignition. The shade component travels between at least one track and pulley system and motor positioned within the A-pillar of a vehicle between the windshield and the pillar trim. When not in use, the shade component is concealed at the base of the dashboard of the vehicle. Further, the top of the shade component comprises a flexible rod, which allows the shade component to conform to the shape of a windshield. The shade component is raised or lowered over a vehicle windshield to keep the vehicle's interior cool and prevent UV damage.

In this manner, the motorized windshield shade device of the present invention accomplishes all of the forgoing objectives and provides users with a device that comprises a sunshade that is motorized for a vehicle. The device keeps a vehicle's interior cool and prevents UV damage. The device is concealed within a dashboard when not in use.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a motorized windshield shade device. The motorized windshield shade device comprises a shade component that can be raised and lowered via a push button or by turning off or starting the vehicle ignition. The shade component travels between at least one track and pulley system and motor positioned within the A-pillar of a vehicle between the windshield and the pillar trim. When not in use, the shade component is concealed at the base of the dashboard of the vehicle. Further, the top of the shade component comprises a flexible rod, which allows the shade component to conform to the shape of a windshield. The shade component is raised or lowered over a vehicle windshield to keep the vehicle's interior cool and prevent UV damage.

In one embodiment, the motorized windshield shade device comprises a shade component which can be raised or lowered, as needed. The shade component may be constructed from at least one of nylon, plastic, vinyl, rubber, and other flexible polymers, etc., but is not limited thereto. Further, the shade component may be constructed of a flexible material, such as polyester, cloth, sheet metal, etc., but is not limited thereto and can comprise any suitable material as is known in the art.

In one embodiment, the shade component can be any suitable shape and size as is known in the art, as long as it is shaped and sized to cover an entire interior vehicle windshield. In one embodiment, the shade component is constructed of a predetermined size to fit a specific interior windshield of a specific vehicle make and model. Generally, the shade component comprises a front surface which contacts a vehicle's interior windshield, a rear surface which faces the interior of the vehicle, opposing side edges, and opposing top and bottom edges.

In one embodiment, the top edge of the shade component comprises a flexible or semi-flexible rod. Specifically, the flexible or semi-flexible rod is secured to a top of the shade component via any suitable securing means as is known in the art, such as Velcro, snaps, adhesive, etc. Further, the flexible or semi-flexible rod allows the shade component to conform to the shape of a windshield, while keeping the shade component taunt to prevent sunlight and UV damage in the vehicle.

In one embodiment, the shade component travels between at least one track and pulley system. Typically, the track and pulley system is a conventional track and pulley as is known in the art. Further, the track and pulley system is positioned within the A-pillar of a vehicle between the windshield and the vehicle's pillar trim, but can be positioned in any suitable area of the vehicle. In use, the shade component slides up the interior of the vehicle windshield to cover the windshield completely and is concealed at a base of the dashboard, when not in use.

In one embodiment, there is a track and pulley system positioned on both sides of the windshield, integrated within the A-pillar of the vehicle. The track and pulley systems may be removably affixed and/or adhered along each side of the vehicle's A-pillar between the windshield and the pillar trim, using an adhesive such as a tape, glue, screws, bolts, and/or a magnet, etc., but is not limited thereto. Each of the track and pulley systems engage side edges of the shade component and may be removably connected to each end of the flexible rod positioned at the top of the shade component. Specifically, the shade component may be removably connected by a sliding clamp or other securing means on the plurality of tracks of the track and pulley system. Moreover, the sliding clamp may move (i.e. slide) within each of the plurality of tracks in response to the motor extending the shade component.

In one embodiment, the shade component comprises a motor which is disposed within an interior portion of the A-pillar. Typically, the motor is in communication with the vehicle bus (i.e., the vehicle's on-board computer) to control functions of the motor. Specifically, the vehicle bus sends signals to tell the motor if the vehicle is off or on. When the ignition is turned on, the motor is activated, raising the shade component to cover the windshield. Then, when the vehicle is turned off, the motor is activated to lower the shade component, allowing a user to clearly see out of the windshield while driving.

In one embodiment, one end of the shade component is mounted to the motor. As a result, rotation by the motor causes the shade component to be appropriately lowered or raised. In one embodiment, the motor has a sensor, which halts clockwise rotation by the motor when the shade component is fully lowered into the dashboard of the windshield, and detects the proximity of the flexible rod to halt counter clockwise rotation by the motor when the shade component is fully raised up the windshield.

In another embodiment, the shade component can be manually raised and lowered via a push button. The push button is in communication with the motor to raise and lower the shade component, as needed. As such, the shade component may prevent an interior of the vehicle from reaching extremely hot temperatures. Therefore, the user may touch at least a portion of the interior of the vehicle without injury due to a hot surface.

In one embodiment, the motor is powered by the vehicle's battery. Thus, a user does not have to worry about a separate battery needing charged and/or replaced, when using the motorized windshield shade device.

In one embodiment, instead of using the vehicle's battery, a separate battery is connected to the motor within the track and pulley system, wherein the battery provides the electrical power necessary for operation of the motor. The separate battery may include lithium-ion, nickel cadmium, nickel metal hydride, alkaline, etc., but is not limited thereto. Further, a manual switch is connected to the motor, such that activating the manual switch causes rotation of the motor. According to the invention, the manual switch allows the user to reverse the motor, so as to selectively rotate the motor in a clockwise or a counterclockwise direction, and thereby deploy or retract the shade component. The manual switch is activated via manually depressing the button, switch, toggle switch, etc.

In one embodiment, in a retracted position, the shade component is disposed within an interior portion of the vehicle dashboard, so as not to be seen when not in use. Further, the shade component, in its retracted position, does not block a user's view of the windshield, when driving the vehicle.

In one embodiment, the shade component is tinted to substantially block sunlight from entering into the vehicle from the front windshield. According to the invention, the shade component may be selectively raised or lowered to allow usage of the shade component as a sun shield. Further, the shade component is raised completely to cover the entire windshield and block sunlight from entering into the interior when the vehicle is parked.

In one embodiment, the user may change the opaqueness of the shade component from a first setting (i.e. clear) to a second setting (i.e. black) and/or any variation therebetween in response to user input. Further, the opaqueness of the shade component may be a cosmetic feature that does not impact the shade component from preventing UV radiation from penetrating the windshield of the vehicle.

In one embodiment, a user can manually raise and lower the shade component via a smart device, such as a mobile phone, a laptop computer, a tablet computer, a desktop computer, a palm pilot, a smart watch, etc., but is not limited thereto, and may be any type of smart device that connects to the Internet or any other type of network, or any other device that may have wireless communication capabilities. The mobile or smart device may perform any type of wireless communication, including, but not limited to, WIFI, BLUETOOTH, RFID, NFC, etc. The device further includes a wireless communication module and additional sensors which would allow the device to pair with a mobile application on a mobile or smart device. Once paired, a user could control the motorized windshield shade device via the mobile application.

In one embodiment, the shade component comprises a slot or opening which allows access of the rearview mirror mounting arm. Generally, most vehicles comprise a factory-installed rearview mirror that is generally mounted on the windshield. Unfortunately, mounting the rearview mirror to the windshield can obstruct the shade component from being raised completely over the windshield, such that the shade component cannot be raised beyond the location of the rearview mirror. The slot or opening allows the shade component to be raised fully over the windshield, protecting the interior of the vehicle, without contacting the rearview mirror mounting arm.

In yet another embodiment, the motorized windshield shade device comprises a plurality of indicia.

In yet another embodiment, a method of blocking sunlight from entering a vehicle through the vehicle windshield is disclosed. The method includes the steps of providing a motorized windshield shade device comprising a shade component that can be raised and lowered. The method also comprises raising the shade component via a track and pulley system positioned within the A-pillar of a vehicle. Further, the method comprises lowering the shade component as needed. Finally, the method comprises keeping a vehicle's interior cool and preventing UV damage via the shade component.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the motorized windshield shade device of the present invention in accordance with the disclosed architecture;

FIG. 2 illustrates a perspective view of one embodiment of the motorized windshield shade device of the present invention showing the track and pulley system integrated in the A-pillar of the vehicle in accordance with the disclosed architecture;

FIG. 3 illustrates a perspective view of one embodiment of the motorized windshield shade device of the present invention showing the integrated track and pulley system in accordance with the disclosed architecture;

FIGS. 4-6 illustrates a perspective view of one embodiment of the motorized windshield shade device of the present invention showing the shade component being raised for use in accordance with the disclosed architecture;

FIG. 7 illustrates a perspective view of one embodiment of the motorized windshield shade device of the present invention showing the interior of the windshield with the shade component raised in accordance with the disclosed architecture;

FIG. 8 illustrates a perspective view of one embodiment of the motorized windshield shade device of the present invention showing the interior of the windshield with the shade component lowered in accordance with the disclosed architecture;

FIGS. 9A-C illustrate a perspective view of one embodiment of the motorized windshield shade device of the present invention showing how the shade component is integrated into the vehicle in accordance with the disclosed architecture;

FIGS. 10A-D illustrate a perspective view of one embodiment of the motorized windshield shade device of the present invention showing how the device is raised and lowered in accordance with the disclosed architecture; and

FIG. 11 illustrates a flowchart showing the method of blocking sunlight from entering a vehicle through the vehicle windshield in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a motorized windshield shade device that provides users with a means for blocking sunlight from entering a vehicle through the vehicle windshield. There is also a long felt need in the art for a motorized windshield shade device that can be easily placed and removed from behind a vehicle windshield. Further, there is a long felt need in the art for a motorized windshield shade device that is a built-in retractable sunshade for vehicle windshields. Moreover, there is a long felt need in the art for a device that utilizes an integrated track and pulley system inside the vehicle's A-pillar. Further, there is a long felt need in the art for a motorized windshield vehicle device that comprises a semi-flexible rod at the top to conform to the windshield. Finally, there is a long felt need in the art for a motorized windshield shade device that is completely hidden behind the dashboard when not in use.

The present invention, in one exemplary embodiment, is a novel motorized windshield shade device. The motorized windshield shade device comprises a shade component that can be raised and lowered via a push button or by turning off or starting the vehicle ignition. The shade component travels between at least one track and pulley system and motor positioned within the A-pillar of a vehicle between the windshield and the pillar trim. When not in use, the shade component is concealed at the base of the dashboard of the vehicle. Further, the top of the shade component comprises a flexible rod, which allows the shade component to conform to the shape of a windshield. The shade component is raised or lowered over a vehicle windshield to keep the vehicle's interior cool and prevent UV damage. The present invention also includes a novel method of blocking sunlight from entering a vehicle through the vehicle windshield. The method includes the steps of providing a motorized windshield shade device comprising a shade component that can be raised and lowered. The method also comprises raising the shade component via a track and pulley system positioned within the A-pillar of a vehicle. Further, the method comprises lowering the shade component as needed. Finally, the method comprises keeping a vehicle's interior cool and preventing UV damage via the shade component.

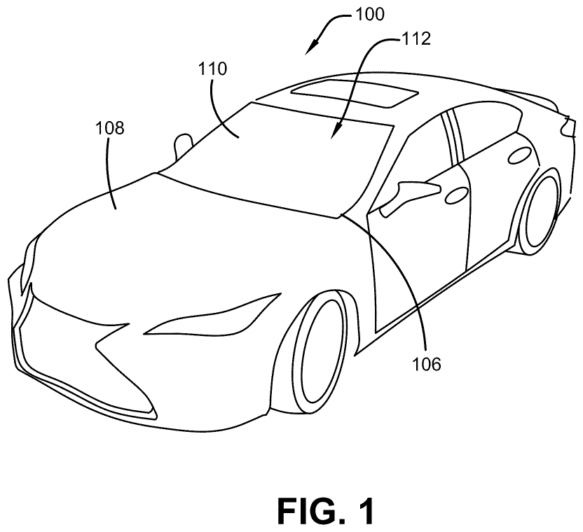

Referring initially to the drawings, FIG. 1 illustrates a perspective view of one embodiment of the motorized windshield shade device 100 of the present invention. In the present embodiment, the motorized windshield shade device 100 is an improved motorized windshield shade device 100 that provides a user with a means for blocking sunlight from entering a vehicle 108 through the vehicle windshield 110. Specifically, the motorized windshield shade device 100 comprises a shade component 102 that can be raised or lowered via a push button 104 or by turning off or starting the vehicle ignition. When not in use, the shade component 102 is concealed at the base of the dashboard 106 of the vehicle 108. Furthermore, the shade component 102 is raised or lowered over a vehicle windshield 110 to keep the vehicle's interior 112 cool and prevent UV damage.

Generally, the motorized windshield shade device 100 comprises a shade component 102 which can be raised or lowered, as needed. The shade component 102 may be constructed from at least one of nylon, plastic, vinyl, rubber, and other flexible polymers, etc., but is not limited thereto. Further, the shade component 102 may be constructed of a flexible material, such as polyester, cloth, sheet metal, etc., but is not limited thereto and can comprise any suitable material or combinations of material as is known in the art.

Further, the shade component 102 can be any suitable shape and size as is known in the art, as long as it is shaped and sized to cover an entire interior vehicle windshield 110. In one embodiment, the shade component 102 is constructed of a predetermined size to fit a specific interior windshield 110 of a specific vehicle 108 make and model. Generally, the shade component 102 comprises a front surface 114 which contacts a vehicle's interior windshield 110, a rear surface 116 which faces the interior 112 of the vehicle 108, opposing side edges 118, and opposing top and bottom edges 120.

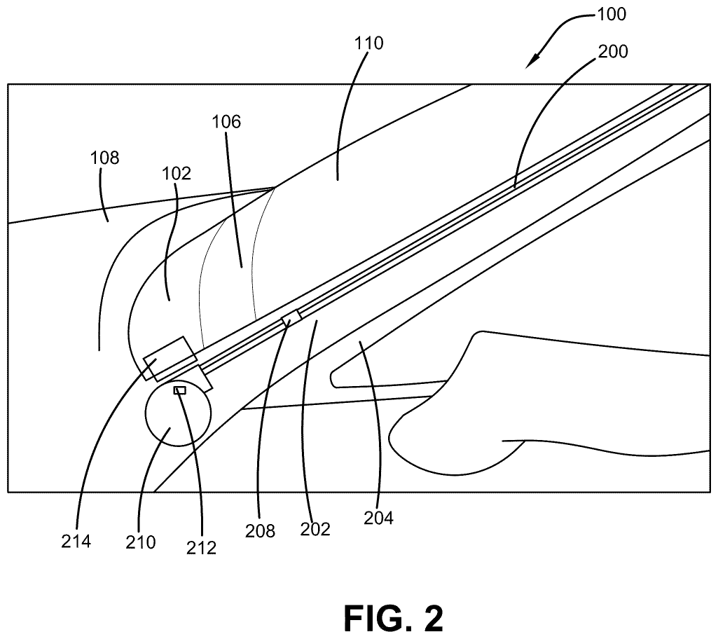

As shown in FIG. 2, the shade component 102 travels between at least one track and pulley system 200. Typically, the track and pulley system 200 is a conventional track and pulley as is known in the art. Further, the track and pulley system 200 is positioned within the A-pillar 202 of a vehicle 108 between the windshield 110 and the vehicle's pillar trim 204, but can be positioned in any suitable area of the vehicle 108. In use, the shade component 102 slides up the interior of the vehicle windshield 110 to cover the windshield 110 completely and is concealed at a base of the dashboard 106, when not in use.

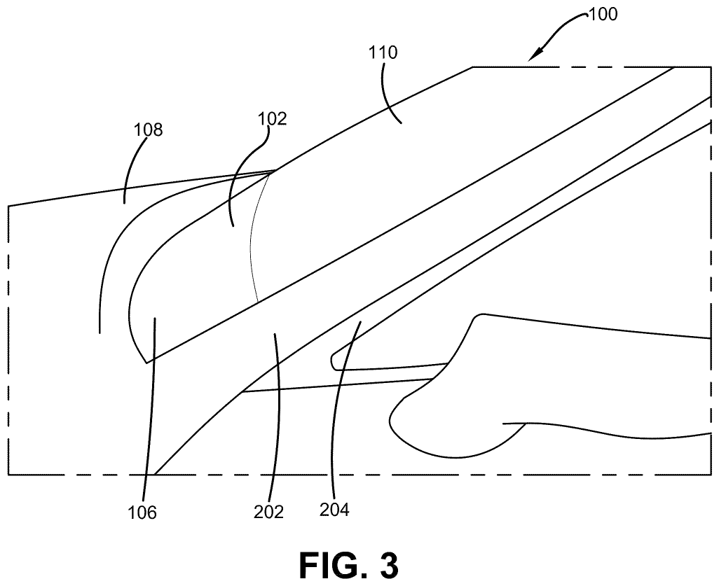

As shown in FIG. 3, in one embodiment, there is a track and pulley system 200 positioned on both sides 118 of the windshield 110, integrated within the A-pillar 202 of the vehicle 108. The track and pulley systems 200 may be removably affixed and/or adhered along each side of the vehicle's A-pillar 202 between the windshield 110 and the pillar trim 204, using an adhesive such as a tape, glue, screws, bolts, and/or a magnet, etc., but is not limited thereto. Each of the track and pulley systems 200 engage side edges 118 of the shade component 102 and may be removably connected to each end of a flexible rod 206 positioned at the top 120 of the shade component 102. Specifically, the shade component 102 may be removably connected by a sliding clamp 208 or other securing means on the plurality of tracks of the track and pulley system 200. Moreover, the sliding clamp 208 may move (i.e. slide) within each of the plurality of tracks in response to a motor 210 extending the shade component 102.

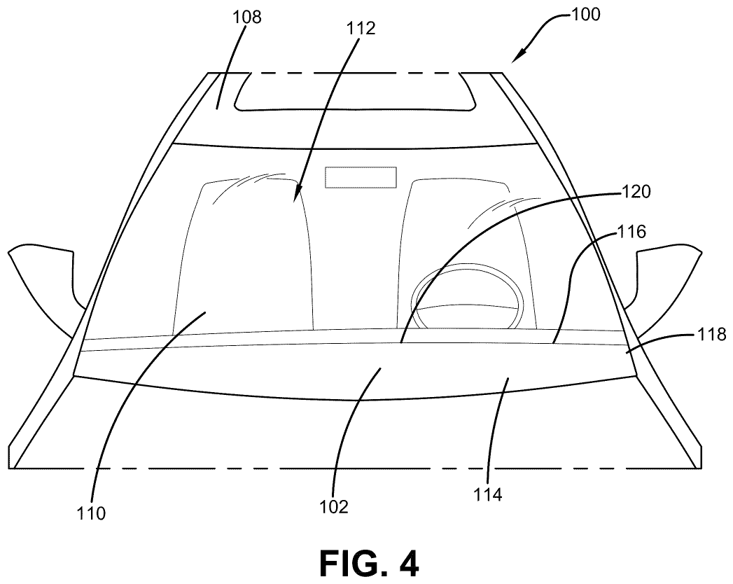

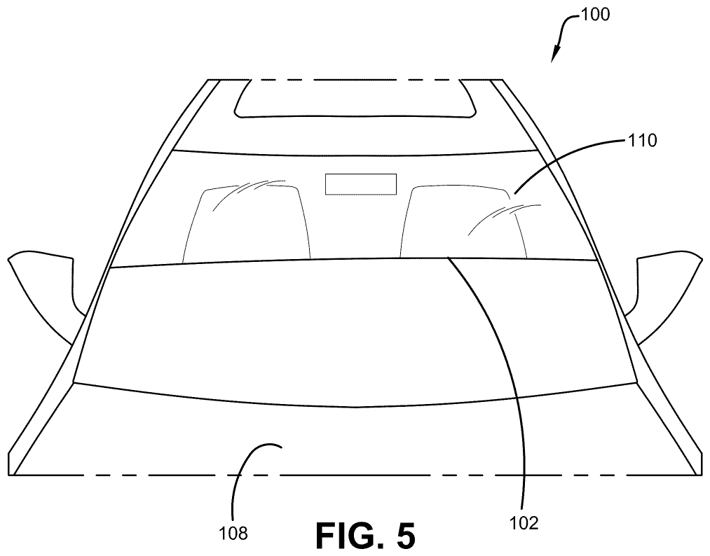

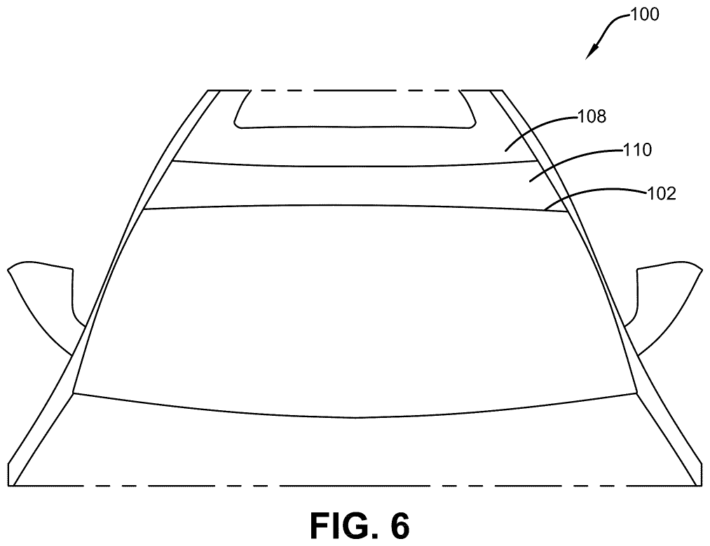

As shown in FIGS. 4-6, the shade component 102 comprises a motor 210 which is disposed within an interior portion of the A-pillar 202. Typically, the motor 210 is in communication with the vehicle bus (i.e., the vehicle's on-board computer) to control functions of the motor 210. Specifically, the vehicle bus sends signals to tell the motor 210 if the vehicle 108 is off or on. When the ignition is turned on, the motor 210 is activated, raising the shade component 102 to cover the windshield 110. Then, when the vehicle 108 is turned off, the motor 210 is activated to lower the shade component 102, allowing a user to clearly see out of the windshield 110 while driving.

Further, in one embodiment, one end 118 or 120 of the shade component 102 is mounted to the motor 210. As a result, rotation by the motor 210 causes the shade component 102 to be appropriately lowered or raised. In one embodiment, the motor 210 has a sensor 212, which halts clockwise rotation by the motor 210 when the shade component 102 is fully lowered into the dashboard 106 of the windshield 110, and detects the proximity of the flexible rod 206 to halt counter clockwise rotation by the motor 210 when the shade component 102 is fully raised up the windshield 110.

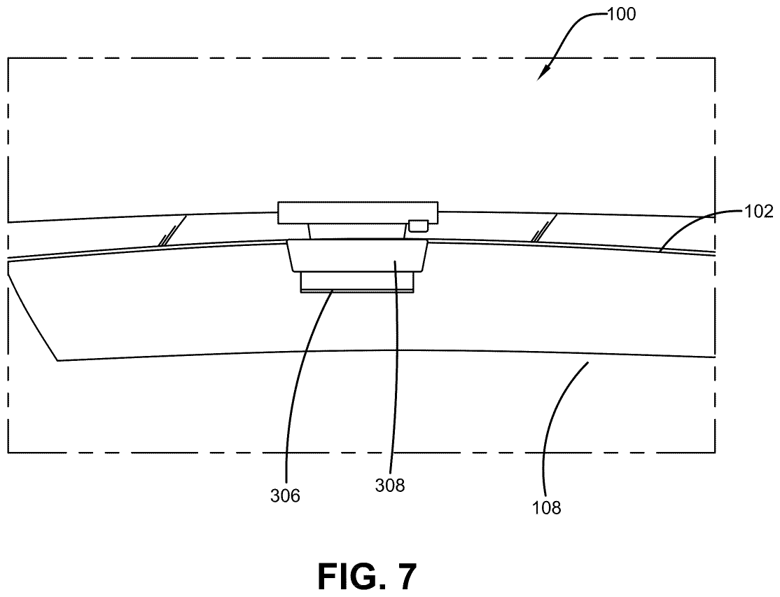

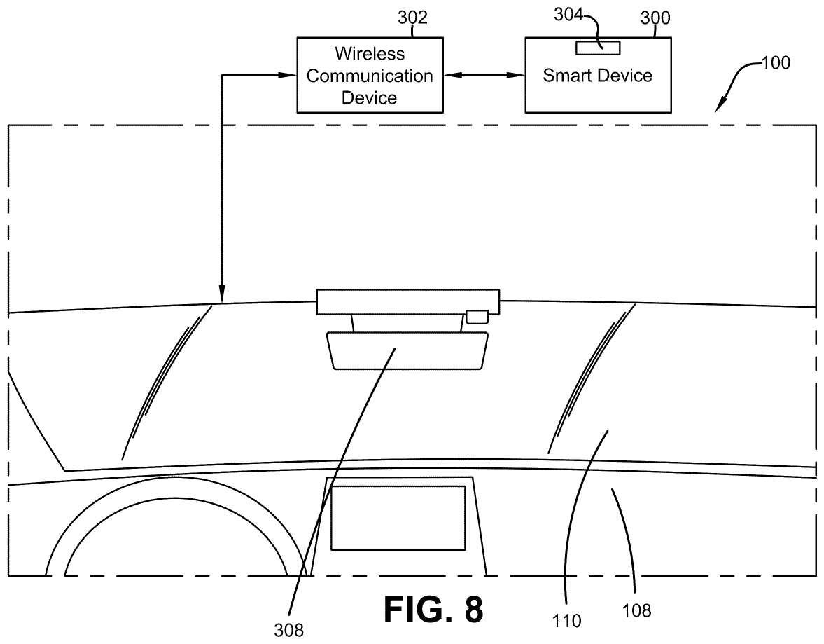

As shown in FIGS. 7-8, the shade component 102 can also be manually raised and lowered via a push button 104. The push button 104 is in communication with the motor 210 to raise and lower the shade component 102, as needed. As such, the shade component 102 may prevent an interior 112 of the vehicle 108 from reaching extremely hot temperatures. Therefore, the user may touch at least a portion of the interior 112 of the vehicle 108 without injury due to a hot surface.

In one embodiment, the motor 210 is powered by the vehicle's battery (not shown). Thus, a user does not have to worry about a separate battery needing charged and/or replaced, when using the motorized windshield shade device 100.

In another embodiment, instead of using the vehicle's battery, a separate battery 214 is connected to the motor 210 within the track and pulley system 200, wherein the battery 214 provides the electrical power necessary for operation of the motor 210. The separate battery 214 may include lithium-ion, nickel cadmium, nickel metal hydride, alkaline, etc., but is not limited thereto. Further, a manual switch 104 is connected to the motor 210, such that activating the manual switch 104 causes rotation of the motor 210. According to the invention, the manual switch 104 allows the user to reverse the motor 210, so as to selectively rotate the motor 210 in a clockwise or a counterclockwise direction, and thereby deploy or retract the shade component 102. The manual switch 104 is activated via manually depressing the button, switch, toggle switch, etc.

Furthermore, in another embodiment, a user can manually raise and lower the shade component 102 via a smart device 300, such as a mobile phone, a laptop computer, a tablet computer, a desktop computer, a palm pilot, a smart watch, etc., but is not limited thereto, and may be any type of smart device 300 that connects to the Internet or any other type of network, or any other device that may have wireless communication capabilities. The mobile or smart device 300 may perform any type of wireless communication, including, but not limited to, WIFI, BLUETOOTH, RFID, NFC, etc. The device 100 further includes a wireless communication module 302 and additional sensors which would allow the device 100 to pair with a mobile application 304 on a mobile or smart device 300. Once paired, a user could control the motorized windshield shade device 100 via the mobile application 304.

Additionally, in one embodiment, the shade component 102 comprises a slot or opening 306 which allows access of the rearview mirror mounting arm 308. Generally, most vehicles 108 comprise a factory-installed rearview mirror 308 that is generally mounted on the windshield 110. Unfortunately, mounting the rearview mirror 308 to the windshield 110 can obstruct the shade component 102 from being raised completely over the windshield 110, such that the shade component 102 cannot be raised beyond the location of the rearview mirror 308. The slot or opening 306 allows the shade component 102 to be raised fully over the windshield 110, protecting the interior 112 of the vehicle 108, without contacting the rearview mirror mounting arm 308.

In yet another embodiment, the motorized windshield shade device 100 comprises a plurality of indicia 600. The shade component 102 of the device 100 may include advertising, a trademark, or other letters, designs, or characters, printed, painted, stamped, or integrated into the shade component 102, or any other indicia 600 as is known in the art. Specifically, any suitable indicia 600 as is known in the art can be included, such as but not limited to, patterns, logos, emblems, images, symbols, designs, letters, words, characters, animals, advertisements, brands, etc., that may or may not be windshield, shade, or brand related.

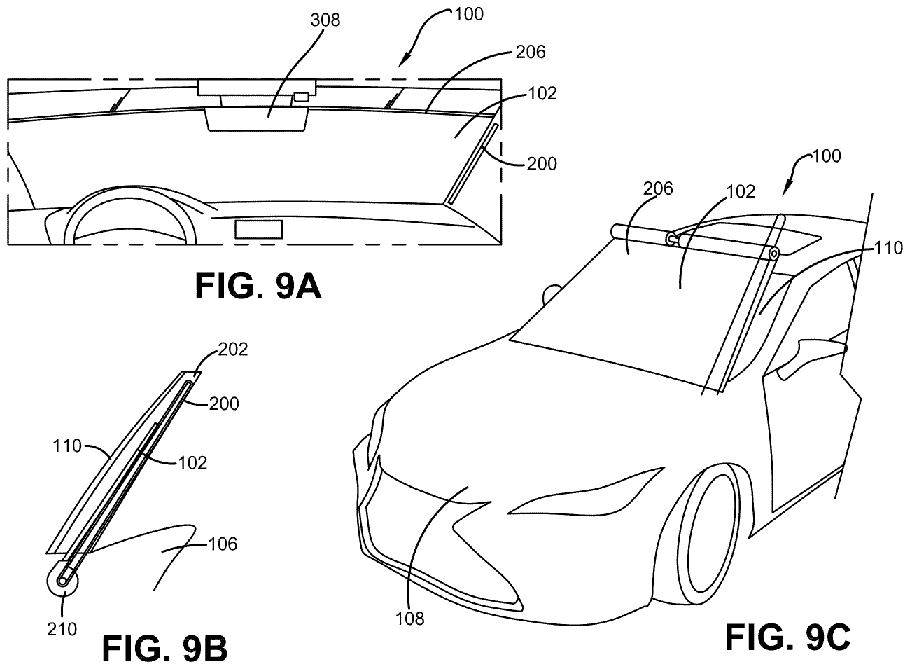

As shown in FIGS. 9A-C, the top edge 120 of the shade component 102 comprises a flexible or semi-flexible rod 206. Specifically, the flexible or semi-flexible rod 206 is secured to a top 120 of the shade component 102 via any suitable securing means as is known in the art, such as Velcro, snaps, adhesive, etc. Further, the flexible or semi-flexible rod 206 allows the shade component 102 to conform to the shape of a windshield 110, while keeping the shade component 102 taunt to prevent sunlight and UV damage in the vehicle 108.

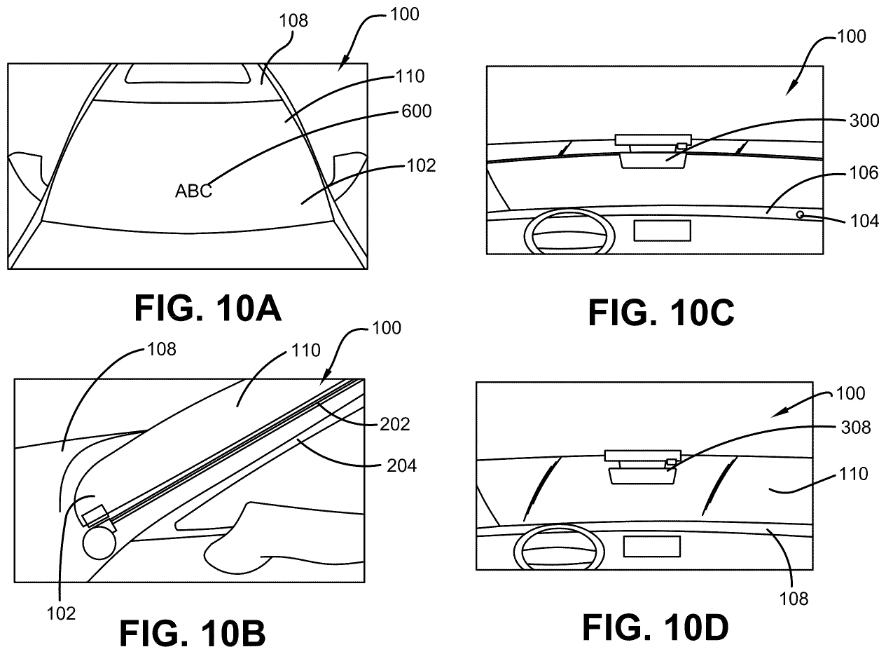

As shown in FIGS. 10A-D, in a retracted position, the shade component 102 is disposed within an interior portion of the vehicle dashboard 106, so as not to be seen when not in use. Further, the shade component 102, in its retracted position, does not block a user's view of the windshield 110, when driving the vehicle 108.

Further, in one embodiment, the shade component 102 is tinted to substantially block sunlight from entering into the vehicle 108 from the front windshield 110. According to the invention, the shade component 102 may be selectively raised or lowered to allow usage of the shade component 102 as a sun shield. Further, the shade component 102 is raised completely to cover the entire windshield 110 and block sunlight from entering into the interior 112 when the vehicle 108 is parked.

Additionally, in another embodiment, the user may change the opaqueness of the shade component 102 from a first setting (i.e. clear) to a second setting (i.e. black) and/or any variation therebetween in response to user input. Further, the opaqueness of the shade component 102 may be a cosmetic feature that does not impact the shade component 102 from preventing UV radiation from penetrating the windshield 110 of the vehicle 108.

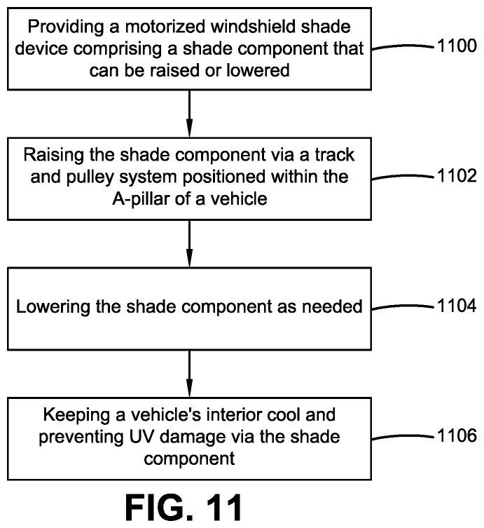

FIG. 11 illustrates a flowchart of the method of blocking sunlight from entering a vehicle through the vehicle windshield. The method includes the steps of at 1100 providing a motorized windshield shade device comprising a shade component that can be raised and lowered. The method also comprises at 1102 raising the shade component via a track and pulley system positioned within the A-pillar of a vehicle. Further, the method comprises at 1104 lowering the shade component as needed. Finally, the method comprises at 1106 keeping a vehicle's interior cool and preventing UV damage via the shade component.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “motorized windshield shade device”, “windshield shade device”, “motorized device”, and “device” are interchangeable and refer to the motorized windshield shade device 100 of the present invention.

Notwithstanding the forgoing, the motorized windshield shade device 100 of the present invention can be of any suitable size and configuration as is known in the art without affecting the overall concept of the invention, provided that it accomplishes the above stated objectives. One of ordinary skill in the art will appreciate that the motorized windshield shade device 100 as shown in FIGS. 1-11 is for illustrative purposes only, and that many other sizes and shapes of the motorized windshield shade device 100 are well within the scope of the present disclosure. Although the dimensions of the motorized windshield shade device 100 are important design parameters for user convenience, the motorized windshield shade device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A motorized windshield shade device that provides a user with a means for blocking sunlight from entering a vehicle through the windshield, the motorized windshield shade device comprising:
a shade component;
a track and pulley system; and
a motor;
wherein the track and pulley system is integrated into a vehicle;
wherein the shade component is secured to the track and pulley system;
wherein the shade component can be raised or lowered over a vehicle windshield via the motor communicating with the track and pulley system; and
further wherein the shade component is raised to cover entire vehicle windshield to keep vehicle interior cool and prevent UV damage.

2. The motorized windshield shade device of claim 1, wherein the shade component comprises a front surface which contacts a vehicle's interior windshield, a rear surface which faces the interior of the vehicle, opposing side edges, and opposing top and bottom edges.

3. The motorized windshield shade device of claim 2, wherein the track and pulley system is positioned within an A-pillar of the vehicle between the vehicle windshield and vehicle's pillar trim.

4. The motorized windshield shade device of claim 3, wherein there is a track and pulley system positioned on both sides of the vehicle windshield, integrated within the A-pillar of the vehicle.

5. The motorized windshield shade device of claim 4, wherein each of the track and pulley systems engage side edges of the shade component and the shade component may be removably connected by a sliding clamp on a plurality of tracks of the track and pulley systems to be raised or lowered by the motor.

6. The motorized windshield shade device of claim 5, wherein in use, the shade component slides up the interior of the vehicle windshield to cover the vehicle windshield completely and is concealed at a base of vehicle dashboard, when not in use.

7. The motorized windshield shade device of claim 6, wherein the motor is in communication with vehicle bus to control functions, such that the vehicle bus sends signals to tell the motor if the vehicle is off or on, and when ignition is turned on, the motor is activated, raising the shade component to cover the vehicle windshield and when the vehicle is turned off, the motor is activated to lower the shade component.

8. The motorized windshield shade device of claim 7, wherein the shade component can be manually raised and lowered via a push button.

9. The motorized windshield shade device of claim 8, wherein the motor is powered by the vehicle's battery.

10. The motorized windshield shade device of claim 8, wherein the motor is powered by a separate battery connected to the motor within the track and pulley system.

11. The motorized windshield shade device of claim 9, wherein a user can manually raise and lower the shade component via a smart device, such as a mobile phone, a laptop computer, a tablet computer, a desktop computer, a palm pilot, or a smart watch.

12. The motorized windshield shade device of claim 11 further comprising a wireless communication module and additional sensors which allow the motorized windshield shade device to pair with a mobile application on the smart device, to control the motorized windshield shade device via the mobile application and smart device.

13. The motorized windshield shade device of claim 12 wherein the top edge of the shade component comprises a flexible rod which allows the shade component to conform to shape of the windshield, while keeping the shade component taunt to prevent sunlight and UV damage in the vehicle.

14. A motorized windshield shade device that provides a user with a means for blocking sunlight from entering a vehicle through the windshield, the motorized windshield shade device comprising:
a shade component comprising a front surface which contacts a vehicle's interior windshield, a rear surface which faces the interior of the vehicle, opposing side edges, and opposing top and bottom edges;
a track and pulley system; and
a motor;
wherein the track and pulley system is integrated into the A-pillar of the vehicle between the vehicle windshield and vehicle's pillar trim;
wherein there is a track and pulley system positioned on both sides of the vehicle windshield, integrated within the A-pillar of the vehicle;
wherein each of the track and pulley systems engage side edges of the shade component and the shade component may be removably connected by a sliding clamp on a plurality of tracks of the track and pulley systems to be raised or lowered by the motor;
wherein the top edge of the shade component comprises a flexible rod which allows the shade component to conform to shape of the windshield, while keeping the shade component taunt to prevent sunlight and UV damage in the vehicle;
wherein the shade component is raised to cover entire vehicle windshield to keep vehicle interior cool and prevent UV damage;
wherein the shade component is concealed at a base of vehicle dashboard, when not in use;
wherein the motor is in communication with vehicle bus to control functions, such that the vehicle bus sends signals to tell the motor if the vehicle is off or on, and when ignition is turned on, the motor is activated, raising the shade component to cover the vehicle windshield and when the vehicle is turned off, the motor is activated to lower the shade component; and
further wherein the shade component can be manually raised and lowered via a push button.

15. The motorized windshield shade device of claim 14, wherein the shade component comprises a slot which allows access of a rearview mirror mounting arm, allowing the shade component to be raised fully over the vehicle windshield, without contacting the rearview mirror mounting arm.

16. The motorized windshield shade device of claim 14, wherein the motor has a sensor, which halts clockwise rotation by the motor when the shade component is fully lowered into the dashboard of the windshield and detects proximity of the flexible rod to halt counter clockwise rotation by the motor when the shade component is fully raised up the vehicle windshield.

17. The motorized windshield shade device of claim 14 further comprising a plurality of indicia.

18. The motorized windshield shade device of claim 14, wherein the shade component is tinted to substantially block sunlight from entering into the vehicle from the windshield.

19. The motorized windshield shade device of claim 18, wherein a user may change opaqueness of the shade component from a first clear setting to a second black setting.

20. A method of blocking sunlight from entering a vehicle through the vehicle windshield, the method comprising the following steps:
providing a motorized windshield shade device comprising a shade component that can be raised and lowered;
raising the shade component via a track and pulley system positioned within the A-pillar of a vehicle;
lowering the shade component as needed; and
keeping a vehicle's interior cool and preventing UV damage via the shade component.
